(19) United States
(12) Patent Application Publication
(10) Pub. No.: US 2007/0110503 A1
(43) Pub. Date: May 17, 2007

(54) Dispensing brush with replaceable cartridge/handle part

(76) Inventor: J. Scott Glover, Irving, TX (US)

Correspondence Address: IP SECTION;GARDERE WYNNE SEWELL LLP, 3000 THANKSGIVING TOWER, SUITE 3000, 1601 ELM STREET, DALLAS, TX, 75201, US

(21) Appl. No.: 11/448,653

(22) Filed: Jun. 7, 2006

Related U.S. Application Data
(60) Provisional application No. 60/731,737, filed on Oct. 31, 2005.

(51) Int. Cl. B43K 5/14; A46B 11/02; B43K 5/02

(52) U.S. Cl. 401/134; 401/188 R; 401/270

(57) ABSTRACT

A dispensing brush includes a replaceable reservoir cartridge and handle part having a reservoir chamber and a material advancing piston disposed therein. The replaceable cartridge and handle part is closed at one end by the piston and, possibly, by a dental floss dispenser having a mirror mounted on a cover therefor. The opposite end of the reservoir is closed by a transverse wall including a rupturable membrane seal. The membrane seal is scored or provided with a reduced wall thickness, cross shaped, frangible portion which is engageable with a projection formed on an adapter part of the brush head so that when the head is connected to the replaceable cartridge and handle part, the seal formed by the rupturable membrane is broken and material, such as toothpaste, may flow to the brush head without becoming contaminated.

### CROSS REFERENCE TO RELATED APPLICATION

This application claims the benefit of U.S. Provisional Patent Application No. 60/731,737, filed Oct. 31, 2005.

### BACKGROUND OF THE INVENTION

In the art of dispensing brushes and the like, several developments have been made including those disclosed in my U.S. patent applications Ser. No. 10/947,006, filed Sep. 21, 2004 (Publication No. US2005-0111905 A1) and Ser. No. 11/071,855, filed Mar. 3, 2005 (Publication No. US2005-0147461 A1). The above identified published patent applications are incorporated herein by reference. The toothpaste dispensing brushes disclosed and claimed in the above-identified applications offer several advantages in the art of dispensing brushes. However, one desirable improvement in brushes of my prior inventions is the provision of a replacement reservoir which is advantageously provided in the brush handle part.

A replaceable paste or other fluid dispensing cartridge and handle part is desirable for several reasons, one being to reduce the cost of replacing the entire improved dispensing brush of my invention when the reservoir is empty. Another reason for having a replaceable reservoir cartridge and handle part is to provide the advantage to change the composition of the paste in the reservoir for the convenience or desires of the user and the ability to carry a replacement paste dispensing reservoir without the space requirements or cost of carrying a complete brush in the event that the dispensing brush being carried should have all paste discharged. Moreover, with the provision of a high quality brush head part, the head part may be reused several times after consumption of all of the material in the original combination paste reservoir cartridge and handle part. It is to these ends that the present invention has been developed.

### SUMMARY OF THE INVENTION

The present invention provides an improved dispensing brush with a replaceable reservoir cartridge and handle part.

In accordance with one aspect of the present invention, a paste dispensing toothbrush is provided with a replaceable handle part which also serves as a toothpaste storage reservoir for dispensing paste through a piston or plunger mechanism and onto the bristles of the brush head part in accordance with my improved brush head structure. The replaceable cartridge and handle part includes a pressure differential actuated piston for urging fluid-like material, such as toothpaste, toward a chamber formed in the brush head in accordance with the construction of the dispensing brushes disclosed and claimed in the above-identified patent applications. The replaceable reservoir cartridge and handle part in accordance with the present invention includes a rupturable seal for maintaining the material in the reservoir fresh and uncontaminated and the seal is broken only when the replacement cartridge and handle part is connected to the brush head part.

Further in accordance with the invention, a dispensing brush head part is provided with an improved adapter part which is operable to provide for engagement with a replaceable reservoir cartridge and handle part and wherein the adapter part is operable to engage and rupture a seal formed in the combination reservoir cartridge and handle part.

The present invention further provides a dispensing brush reservoir cartridge and handle part having a unique configuration which is adapted to be connected to a brush head part for minimizing the chance of contamination of material in the reservoir of the handle part wherein the reservoir is closed by a rupturable membrane which is recessed in a cylindrical tubular housing member of the cartridge and handle part and the membrane may be integrally formed with the housing member. The invention still further provides a dispensing brush which includes a mirror advantageously disposed on a cover member of the handle part and which encloses a floss dispenser.

Those skilled in the art will further appreciate the above-mentioned advantages and superior features of the invention together with other important aspects thereof upon reading the detailed description which follows in conjunction with the drawings.

### BRIEF DESCRIPTION OF THE DRAWINGS

FIG. 1 is a cutaway perspective view of a dispensing brush with a replaceable reservoir cartridge and handle part in accordance with the present invention;

FIG. 2 is a longitudinal central section view of the dispensing brush and replaceable cartridge and handle part in accordance with the invention;

FIG. 3 is a side elevation of the tubular housing member of the reservoir cartridge and handle part shown in FIGS. 1 and 2;

FIG. 4 is a section view taken generally along the line 4-4 of FIG. 3;

FIG. 5 is an end view of the tubular housing member shown in FIGS. 3 and 4; and

FIG. 6 is a detail section view on a larger scale of the area within the circle identified by the numeral 6 in FIG. 4.

### DETAILED DESCRIPTION OF A PREFERRED EMBODIMENT

In the description which follows, like parts are marked throughout the specification and drawing with the same reference numerals, respectively. The drawing figures are not necessarily to scale and certain features may be shown exaggerated in scale or in somewhat generalized form in the interest of clarity and conciseness.

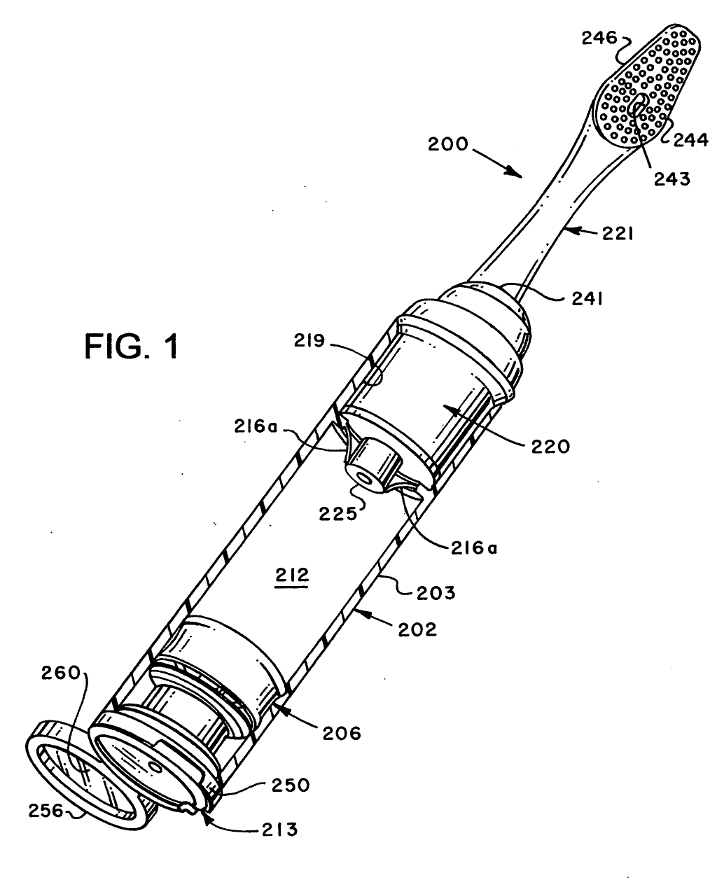

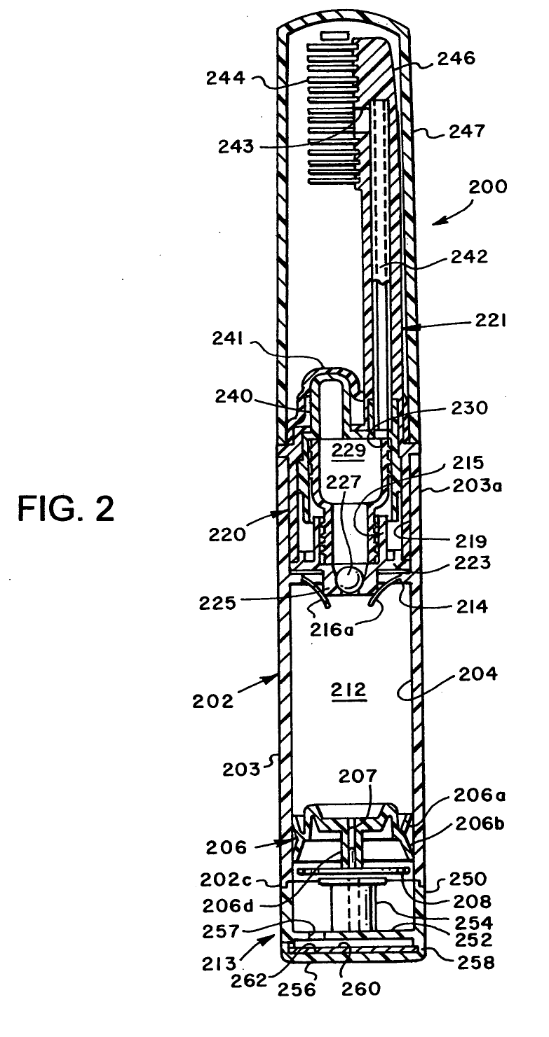

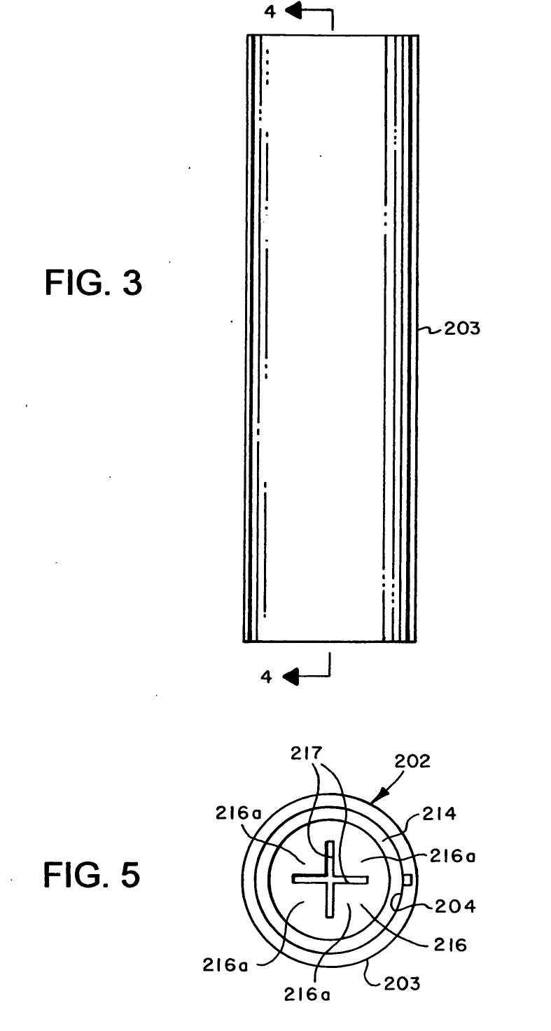

Referring now to FIGS. 1 and 2, a dispensing brush 200 includes a generally cylindrical cartridge and handle part 202 characterized by a cylindrical tubular housing member 203 having a cylindrical borewall 204 for receiving a piston 206 slidably therein. Piston 206 has a central port 207, FIG. 2, formed therein and opposed borewall engaging lip seal portions 206a and 206b, FIG. 2, which are somewhat frustoconical shaped and are integral with a hub part 206d. Piston 206 is adapted to receive a disc-shaped cap or cover 208 having a central pin part insertable in port 207 for closing same. A floss dispenser 213 is, preferably, disposed on the handle part 202 also, as shown, in FIGS. 1 and 2.

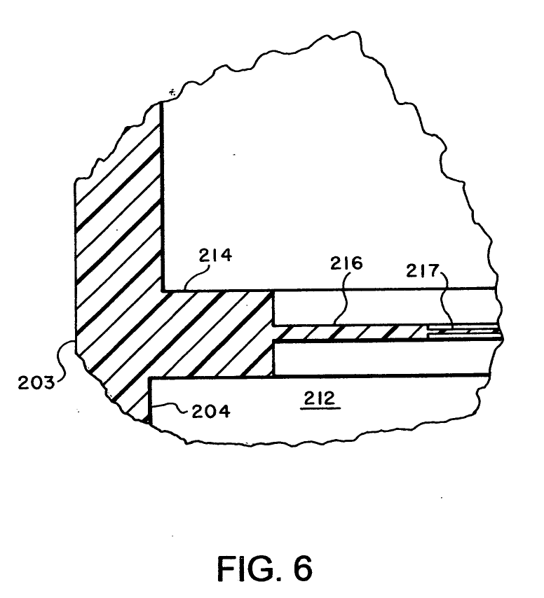

Replaceable reservoir cartridge and handle part 202 defines a reservoir chamber 212 closed at one end by the piston 206 and at an opposite end by a transverse ringlike integral wall part 214. A disc shaped thin walled rupturable membrane seal part is integral with and disposed radially inward of wall part 214 and includes a somewhat cross-shaped frangible portion 217, see FIGS. 5 and 6, which is of a further reduced thickness as compared with membrane 216 and wall part 214, both as shown in FIG. 6. Accordingly, the cross shaped frangible portion 217 allows the membrane part 216 to be ruptured into four leaves 216a, FIG. 5, for example, which remain integral with or connected to the transverse wall part 214 but allow the reservoir 212 to be exposed to additional structure of the brush as described hereinbelow for dispensing flowable or fluid-like material, such as toothpaste, from the reservoir 212.

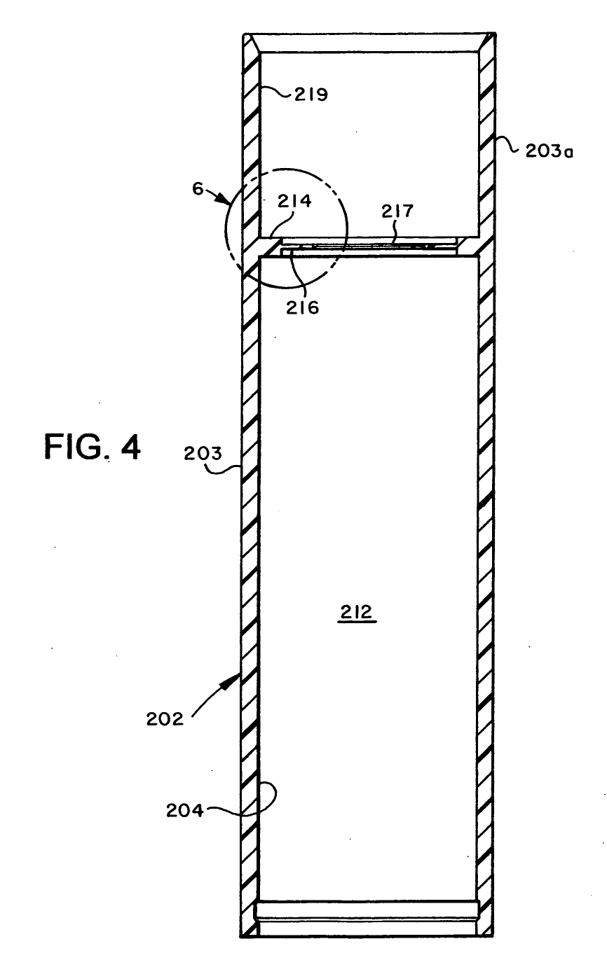

Referring further to FIG. 2 and FIG. 4, the housing member 203 of cartridge and handle part 202 includes an upper cylindrical tubular end portion 203a provided with a cylindrical borewall 219 adapted to be a snug fit over a generally cylindrical downwardly projecting brush head adapter part 220 of a brush head assembly 221, FIGS. 1 and 2. Accordingly, a replacement cartridge and handle part 202 may be formed to be a snug fit of the upper end 203a with the adapter 220. Other means for releasably connecting the cartridge and handle part 202 to the adapter part 220 may be provided, including various forms of a twist and lock type connection, cooperating coarse or fine threads, a so-called bayonet type connection and/or a so-called J-slot type connection between the cartridge and handle part 202 and the adapter 220 of head assembly 221.

Referring further to FIG. 2, in particular, adapter 220 includes a transverse bottom wall 223 from which projects, in one direction, a generally cylindrical boss 225 and, in the opposite direction, a cylindrical tubular projection 215 extending upwardly, viewing FIG. 2. Downwardly projecting cylindrical boss 225 also forms a seat for a check valve closure member 227 to allow material from reservoir 212 to enter an interior chamber 229 of a flexible cylindrical plunger 230 while preventing flow of such material in the opposite direction. Accordingly, when the replaceable reservoir cartridge and handle part 202 is connected to the adapter 220, the projection 225 forcibly engages the membrane 216 and ruptures the membrane at the cross shaped thin walled frangible portion 217 whereby the four leaves 216a, FIG. 5, are formed and are deflected but remain integral with the transverse wall part 214 to avoid blocking the flow of material upward from reservoir chamber 212 past closure member 227 and to chamber 229. Of course, when replaceable cartridge and handle part 202 is removed from the adapter 220, the closure member 227 will engage its seat in the position shown in FIG. 2 to prevent backflow of material from chamber 229 to the exterior of the brush head assembly 221 until a new replaceable cartridge and handle part is connected to the adapter.

In most other respects, the brush head assembly 221 is constructed generally in accordance with the paste dispensing brush disclosed and claimed in my copending patent application Ser. No. 11/071,855, also published as Patent Application Publication No. US 2005/0147461 A1. However, briefly, viewing FIG. 2, dispensing brush 200 includes a plunger actuator 240 including a resilient elastomeric cover part 241 formed therewith. Plunger actuator 240 is slidable downwardly in adapter 220 to cause displacement of resilient plunger 230. Downward movement of the plunger actuator 240 also causes downward movement of a dispensing brush feed tube 242, FIG. 2, to uncover a dispensing port 243 for dispensing material, such as toothpaste, onto a set of brush bristles 244 in a manner consistent with the description in the above-identified patent application publication. Bristles 244 are formed on a distal head part 246 also in a manner consistent with the description in the above-identified patent application publication. FIG. 2 further illustrates a removable, protective cover 247 disposed on head assembly 221.

Referring further to FIG. 2, primarily, the aforementioned floss dispenser 213 includes a generally cylindrical body part 250 suitably secured to an end portion 202c of handle part 202 and provided with a transverse wall 252 supporting a spool or bobbin 254 for a quantity of floss, not shown. A cap or cover 256 is secured to body part 250 at an integral living hinge 258, preferably. Cap 256 is advantageously adapted to support a plain or magnifying mirror 260 suitably secured to an inner surface 262 of cap 256. In the position shown in FIG. 2, cap 256 is shown closed over the end of body part 250. However, cap 256 may be swung to an open position, as shown in FIG. 1, to allow access to a quantity of floss which may extend through a port 257 in transverse wall 252. Cap 256, in its open position shown, permits viewing of the mirror 260.

The operation of the dispensing brush 200 is believed to be within the purview of those skilled in the art based on the foregoing description and by reference to the above-identified patent application publications. Fluid-like cleaning and/or polishing material, such as toothpaste, is continually urged by piston 206 to flow from reservoir 212 into chamber 229 upon unseating of the check valve closure member 227. Upon actuation of the plunger actuator 240 feed tube 242 is moved downwardly viewing FIG. 2, together with the actuator 240, and the deformation of the plunger 230 will reduce the volume of chamber 229 to cause material to flow upward through the tube 242, out of port 243 and onto the bristles 244. When the plunger actuator 240 is released, the elastic memory of the plunger 230 causes the plunger to assume the position shown in FIG. 2 increasing the volume of chamber 229 and allowing material to flow from reservoir 212 past the check valve closure member 227 into the chamber 229. Piston 206 senses a pressure differential created by the flow of material out of reservoir chamber 212 and advances toward the projection or boss 225 in a way known and as described in the above-referenced patent application publications. Moreover, the hinged cap 256 and internally mounted mirror 260 are advantageous for allowing viewing one's teeth during and after a cleaning operation, as desired. Although the cap 256 is illustrated and described as part of a floss dispenser, the cap 256 and mirror 260 could be provided on or as part of an end part of the handle part housing 203 without the inclusion of a floss dispenser, as shown and described.

The replaceable reservoir cartridge and handle part 202 thus adds versatility and convenience to the inventive dispensing brush 200. The replaceable cartridge and handle part 202 may be constructed of the same materials as described in the above-mentioned published patent applications. The brush 200 and replaceable cartridge and handle part 202 are adapted for use as a toothbrush although adaptation to other uses as a cleaning and/or polishing brush assembly is contemplated by the invention. A preferred embodiment of the invention has been described in detail herein. Those skilled in the art will recognize that various substitutions and modifications may be made without departing from the scope and spirit of the invention.

What is claimed is:

1. In a dispensing brush including a head assembly and a generally cylindrical adapter part connected to said head assembly, a replaceable reservoir cartridge and handle part adapted to be releaseably connected to said adapter part and containing a quantity of flowable cleaning paste material therein for flow into and through said head assembly.

2. The dispensing brush set forth in claim 1 wherein:
said handle part defines a reservoir chamber closed at one end by a movable piston and at an opposite end by a transverse rupturable membrane engageable with a boss formed on said adapter part and responsive to said engagement to rupture to expose said chamber to a flowpath in said head assembly.

3. The dispensing brush set forth in claim 2 wherein:
said handle part includes a cylindrical tubular end part providing a bore wall adapted to be engaged with said adapter part for receiving said adapter part therein and said membrane part is disposed spaced from an end of said cylindrical tubular end part for receiving said adapter part to rupture said membrane.

4. The dispensing brush set forth in claim 2 wherein:
said membrane comprises a generally cylindrical disk shaped part integral with a ringlike transverse wall part.

5. The dispensing brush set forth in claim 4 wherein:
said membrane includes a thin walled frangible portion of further reduced thickness as compared with said membrane and rupturable to form plural leaves integrally joined to said transverse wall part but displaceable to provide exposure of one end of said boss to said reservoir chamber for receiving said flowable material within said head assembly.

6. The dispensing brush set forth in claim 2 wherein:
said handle part includes a generally cylindrical bore wall defining, in part, said chamber and said piston is disposed for movement within said chamber to displace said flowable material therefrom.

7. The dispensing brush set forth in claim 6 including:
a cap disposed on an end of said handle part opposite an end which receives said adapter part.

8. The dispensing brush set forth in claim 7 including:
a floss dispenser comprising a body part and said cap is hingedly connected to said body part for movement between open and closed positions to permit access to floss disposed on said dispenser.

9. The dispensing brush set forth in claim 7 including:
a mirror disposed on an inside surface of said cap to provide for viewing one's teeth during use of said dispensing brush.

10. In a dispensing brush including a head assembly and an adapter part connected to said head assembly, a replaceable reservoir cartridge and handle part releasably connected to said adapter part for containing a quantity of flowable cleaning paste material therein for flow into and through said head assembly, said handle part includes an end part providing a wall adapted to be engaged with said adapter part for receiving said adapter part therein and a membrane disposed spaced from an end of said end part for receiving said adapter part to rupture said membrane, said membrane comprises a disk shaped part integral with a ringlike transverse wall part.

11. The dispensing brush set forth in claim 10 wherein:
said membrane includes a thin walled frangible portion of further reduced thickness as compared with said membrane and rupturable to form plural leaves integrally joined to said transverse wall part but displaceable to provide exposure to said reservoir chamber for transferring said flowable material to said head assembly.

12. The dispensing brush set forth in claim 10 including:
a floss dispenser mounted on an end of said handle part opposite an end which receives said adapter part.

13. The dispensing brush set forth in claim 12 wherein:
said floss dispenser includes a body part and a cap hingedly connected to said body part for movement between open and closed positions to permit access to floss disposed on said dispenser.

14. The dispensing brush set forth in claim 13 including:
a mirror disposed on an inside surface of said cap to provide for viewing one's teeth during use of said dispensing brush.

15. In a dispensing brush including a head assembly and a generally cylindrical adapter part connected to said head assembly, a reservoir cartridge and handle part connected to said adapter part and containing a quantity of flowable cleaning paste material therein for flow into and through said head assembly, said handle part defines a reservoir chamber closed at one end by a movable piston, said handle part includes a cylindrical tubular end part providing a bore wall adapted to be engaged with said adapter part for receiving said adapter part, and a floss dispenser mounted on an end of said handle part opposite said end part which receives said adapter part, said floss dispenser including a body part and a cap hingedly connected to said body part for movement between open and closed positions to permit access to floss disposed on said dispenser.

16. The dispensing brush set forth in claim 15 including:
a mirror disposed on an inside surface of said cap to provide for viewing one's teeth during use of said dispensing brush.
